(19) United States
(12) Patent Application Publication
(10) Pub. No.: US 2026/0280309 A1
(43) Pub. Date: Sep. 17, 2026

(54) TOOL-TO-TOOL CHARGING

(71) Applicant: MILWAUKEE ELECTRIC TOOL CORPORATION, Brookfield, WI (US)

(72) Inventor: Anil Kumar Vangara, Chicago, IL (US)

(21) Appl. No.: 19/558,058

(22) Filed: Mar. 5, 2026

Related U.S. Application Data
(60) Provisional application No. 63/770,180, filed on Mar. 11, 2025.

(51) Int. Cl. H02J 7/34; H01M 10/44; H02J 7/00; H02J 7/42; H02J 7/60; H02J 7/80

(52) U.S. Cl. CPC H02J 7/342; H01M 10/441; H02J 7/42; H02J 7/685; H02J 7/80; H02J 7/855; H02J 2207/20; H02J 2207/30

(57) ABSTRACT

One embodiment provides a power tool including an interface for receiving a power tool battery pack, a port, a port controller connected to the port, and a controller coupled to the interface and the port controller. The port controller is configured to set the port in one of a source mode and a sink mode. The controller is configured to determine that a power device is connected via the port, negotiate power transfer between the power tool and the power device, and set, using the port controller, the port in one of the source mode and the sink mode based on the power transfer.

### CROSS-REFERENCE TO RELATED APPLICATION

This application claim priority to, and the benefit of, U.S. Provisional Application No. 63/770,180, filed on Mar. 11, 2025, the entire contents of which are incorporated herein by reference.

### FIELD

The present disclosure relates to power tool charging using another power tool.

### BACKGROUND

Power tool battery pack chargers are bulky and require an alternating current (AC) power supply to charge battery packs. Traditionally, when AC power is unavailable or a user is unable to transport a charger, they run the risk of not being able to use the power tool without other charging solutions.

### SUMMARY

The utility of many power tools comes from the portable nature of the power tools. The portable power tools allow a user to be mobile and easily accomplish jobs. However, many users’ mobility is hindered when their power tool battery pack is depleted and they must revert to a power tool battery pack charger. Often, these chargers are provided at a stationary location near an AC outlet, which might be inconvenient for the user and cause work delays. Accordingly, there is a need for a power tool portable charging solution that is easy and convenient. For example, a power tool battery pack may be charged with another power tool, a compact wall adapter, a printer, or a top-off device using power from another power tool battery pack. The power tool battery pack is charged using power transferred via a universal serial bus type c (USB-C) charging port with power delivery (PD) provided on the power tool. The power tool battery pack may be charged using a USB-C PD standard power range (SPR) or using a USB-C PD extended power range (EPR). The versatility of the charging port on the power tool allows the battery pack to be charged a multitude of ways, depending upon the available power source(s).

One embodiment provides a power tool comprising an interface for receiving a power tool battery pack, a port, a port controller connected to the port and configured to set the port in one of a source mode and a sink mode, and controller coupled to the interface and the port controller. The controller is configured to determine that a power device is connected via the port, negotiate power transfer between the power tool and the power device, and set, using the port controller, the port in one of the source mode and the sink mode based on the power transfer.

A further embodiment provides a system including a first power tool including a first power port, a cable including a first end and a second end and connecting to the first power port at the first end, and a second power tool. The second power tool includes a second power port connected to the cable at the second end, an interface for receiving a power tool battery pack, a port controller connected to the second power port and configured to set the second power port in one of a source mode and a sink mode, and a controller coupled to the interface and the port controller. The controller is configured to determine the first power tool is connected via the port, negotiate power transfer between the second power tool and the first power tool, and set, using the port controller, the port in one of the source mode and the sink mode based on the power transfer.

An even further embodiment provides a method of charging a first power tool with a second power tool. The method includes determining, with an electronic processor of the first power tool, that the second power tool is connected via a port of the first power tool, negotiating, with the electronic processor of the first power tool, power transfer between the first power tool and the second power tool, and setting, using a port controller of the first power tool, a port of the first power tool in one of a source mode and a sink mode based on the power transfer.

Other aspects of the embodiments will become apparent by consideration of the detailed description and accompanying drawings.

### BRIEF DESCRIPTION OF THE DRAWINGS

FIG. 1 is a perspective view of a power tool, according to some embodiments.

FIG. 2 is a perspective view of a battery pack for powering the power tool of FIG. 1, according to some embodiments.

FIG. 3 illustrates tool-to-tool charging for the power tool of FIG. 1, according to some embodiments.

FIG. 4 is a block diagram illustrating a discharge of a first power tool to a second power tool, according to some embodiments.

FIG. 5 is a block diagram illustrating a discharge of the second power tool to the first power tool, according to some embodiments.

FIG. 6 illustrates a first charging system for the power tool of FIG. 1, according to some embodiments.

FIG. 7 is a block diagram of the power tool of FIG. 1, according to some embodiments.

FIG. 8 is a flowchart illustrating a method for tool to tool charging, according to some embodiments.

FIG. 9 is a flowchart illustrating a method for tool to tool charging, according to some embodiments.

Before any embodiments are explained in detail, it is to be understood that the embodiments are not limited in their application to the details of construction and the arrangement of components set forth in the following description or illustrated in the following drawings. The embodiments are capable of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Additionally, unless otherwise noted, terms of approximation, such as “about,” approximately,” and “substantially,” at least when used with numerical values, may refer to within 1%, 2.5%, 5%, or 10% of the noted value.

### DETAILED DESCRIPTION

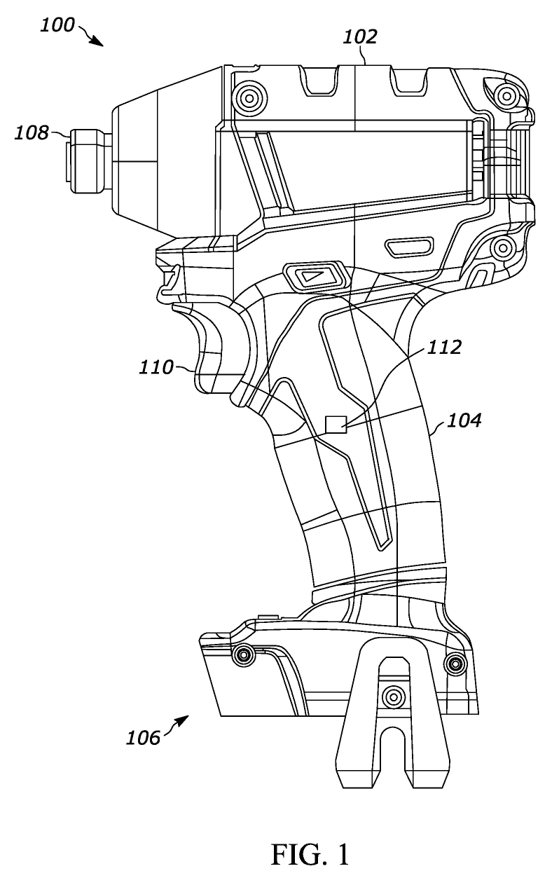

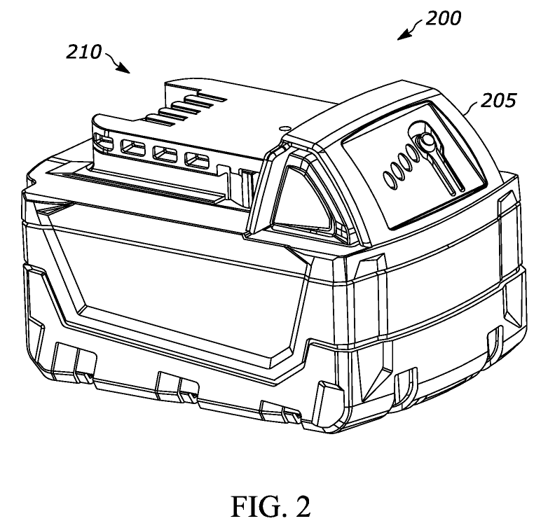

FIG. 1 illustrates an example embodiment of a power tool 100. The power tool 100 is, for example, an impact driver including an upper main body 102, a handle 104, a battery pack receiving portion 106, an output drive device or mechanism 108, a trigger 110, and a power port 112. In one example, the power tool 100 further includes a motor within the main body 102 of the housing and having a rotor and a stator. The rotor is coupled to a motor shaft arranged to produce an output outside of the housing via the output drive device or mechanism 108. The housing of the power tool 100 (e.g., the main body 102 and the handle 104) is composed of a durable and light-weight plastic material. The drive device 108 is composed of a metal (e.g., steel) output spindle. The battery pack receiving portion 106 is configured to receive and couple to a battery pack, such as a battery pack 200 (FIG. 2) that provides power to the power tool 100. The battery pack receiving portion 106 includes a connecting structure to engage a mechanism that secures the battery pack and a terminal block to electrically connect the battery pack 200 to the power tool 100.

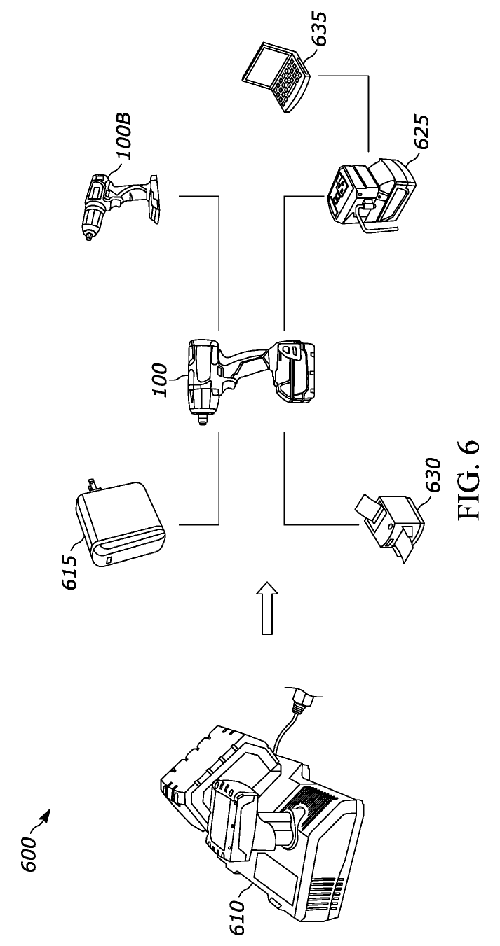

The battery pack receiving portion 106 may further include terminals to transfer power and data to/from the battery pack 200. For example, the terminals may include a power terminal (e.g., a positive power terminal and a negative power terminal or ground terminal), a charging terminal, and a data communication terminal. The charging terminal may transfer power to/from the battery pack 200 to another power tool or other device, as described below with respect to FIG. 6. In some embodiments, the power tool 100 may be an alternating current (AC) powered power tool that includes a rectifier to provide a DC voltage to the motor. In some embodiments, the power tool 100 is a type of tool that is capable of charging the battery pack 200. Power tools 100 capable of charging the battery pack 200 include a charging terminal separate from the positive and negative power terminals in the terminal block and power tools that cannot charge the battery pack 200 do not include a separate charging terminal.

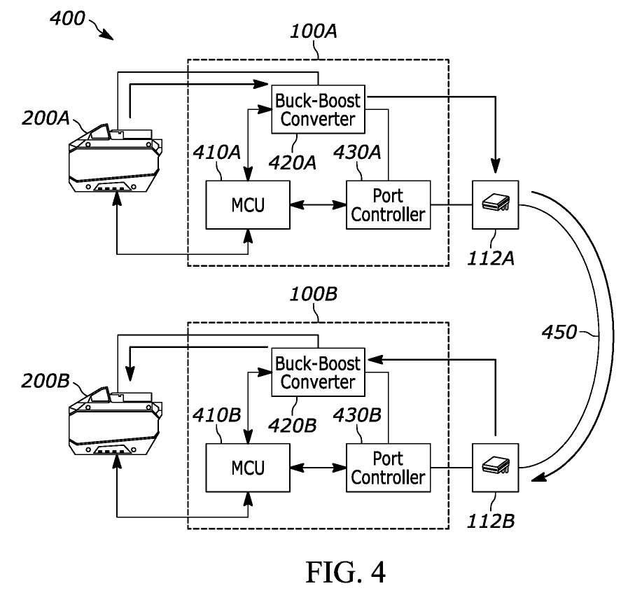

The power port 112 may be a USB or USB-C power port that receives a cable (e.g., USB cable or USB-C cable). The power port 112 may be provided on the handle 104 of the power tool 100. The power port 112 is configured to transfer and/or receive power in a range of 0 Watts (W) – 240 W. For example, the power port 112 may transfer power according to a USB PD EPR standard and/or a USB PD SPR standard. The power port 112 may be configured in a first manner for a tool transferring and/or receiving power according to the USB PD EPR standard and in a second manner for a tool transferring and/or receiving power according to the USB PD SPR standard. The cable may be an electronically marked cable (e.g., the cable includes a communication component for communicating between a power source and power sink device) when a USB PD EPR standard is used. In some examples, the power port 112 is capable facilitating dual-rate charging (e.g., 100 W or 240 W). The power port 112 may be in electrical connection with the charging terminal, as well as other components as described below in FIG. 4.

FIG. 1 illustrates an impact wrench, however, the power tool 100 may include drills, circular saws, jig saws, band saws, reciprocating saws, screw drivers, angle grinders, straight grinders, hammers, multi-tools, impact wrenches, rotary hammers, impact drivers, angle drills, powered ratchets, powered torque wrenches, hydraulic pulse tools, hydraulic tensioning tools, lock bolt installation tools, reaction arm tools, riveting tools, nailers, staplers, TC bolt guns, and the like.

FIG. 2 illustrates a battery pack 200, according to some embodiments. The battery pack 200 is a power tool battery pack that is generally used to power a power tool, such as the power tool 100. The battery pack 200 includes a housing 205 and an interface portion 210 for connecting the battery pack 200 to a device (e.g., the power tool 100). In some embodiments, the battery pack 200 includes lithium-ion battery cells. In other embodiments, the battery pack 200 may be of a different chemistry, for example, nickel-cadmium, nickel-metal hydride, and the like. In the illustrated embodiment, the battery pack 200 is an 18 Volt (V) battery pack. In other embodiments, the output voltage level of the battery pack 200 may be different. For example, the battery pack 200 can be a 4V battery pack, 28Vbattery pack, 36Vbattery pack, 72Vbattery pack or another voltage (voltage here may refer to nominal voltage). The battery pack 200 may also have various capacities (e.g., 3, 4, 5, 6, 8, or 12 ampere-hours).

The battery pack 200 also includes terminals to connect to the power tool 100. The terminals for the battery pack 200 includes a positive and a negative terminal to provide power to the battery pack 200. The terminals include a charging terminal to receive power from the power tool 100 or a charger. In some embodiments, the battery pack 200 also includes data terminals to communicate with the power tool 100. For example, the battery pack 200 may include a microcontroller to monitor one or more characteristics of the battery pack 200 and the data terminals may communicate with the power tool 100 regarding the monitored characteristics. The battery pack 200 may also include a power port, similar to power port 112.

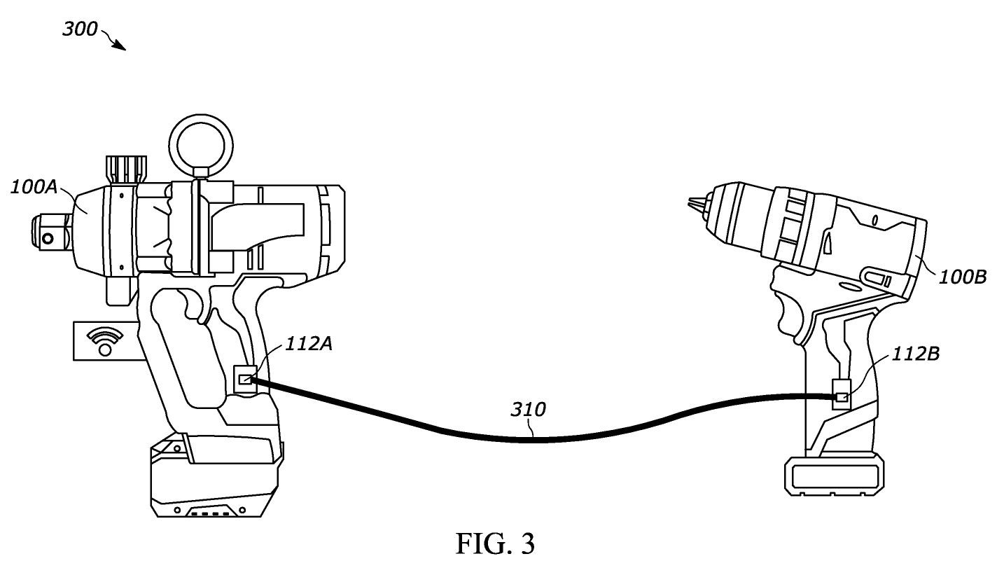

FIG. 3 is a tool-to-tool charging system 300, according to some embodiments. The tool-to-tool charging system 300 includes a first power tool 100A and a second power tool 100B. The second power tool 100B may be substantially the same as the first power tool 100A. The first power tool 100A and the second power tool 100B are connected to one another via a cable 310. For example, the cable 310 is received at the first power port 112A of the first power tool 100 (e.g., first charging port) at a first end and a second power port 112B of the second power tool 100B at a second end. The cable 310 may be one of a USB-C PD cable and a USB PD cable. The cable 310 may be electronically marked.

FIG. 4 is a block diagram 400 illustrating an example discharge of the first power tool 100A to the second power tool 100B. The first power tool 100A and the second power tool 100B may be substantially the same as the power tool 100 (FIG. 1). The first power tool 100A is connected to a first battery pack 200A and the second power tool 100B is connected to a second battery pack 200B. The first battery pack 200A and the second battery pack 200B may be substantially the same as the battery pack 200 (FIG. 2). The first power tool 100A includes a first microcontroller 410A, a first power converter 420A, a first port controller 430A, and a first power port 112A. The first microcontroller 410A is communicatively connected to the first battery pack 200A (e.g., a controller of the first battery pack 200A), the first power converter 420A, and the first port controller 430A via one or more buses. The first power converter 420A is connected between the first battery pack 200A and the first power port 112A (e.g., via the first port controller 430A).

During discharge, the first battery pack 200A provides a first voltage to the first power converter 420A, e.g., via positive and negative power terminals of the first battery pack 200A and the first power tool 100A respectively. The first power converter 420A may increase or decrease the first voltage to a second voltage based on input from the first port controller 430A and provides the second voltage to the first power port 112A. For example, the first voltage may be 12V, 18V, or 72V depending on the power tool (e.g., a voltage rating of the first power tool 100A). The second voltage may be in a range of 5V – 48V. The second voltage may be based on one or both of (a) a power rating of the second power tool 100B and/or the second battery pack 200B and (b) a power transfer standard (e.g., USB-C PD SPR standard or USB-C PD EPR standard). As one example, when using the SPR standard, the first port controller 430A may provide an output power in a range of 0 Amps (A) – 5A for volage in a range of 5V – 20V, and when using the EPR standard, the first port controller 430A provides an output power in a range of 0A – 5A for voltage in a range of 15V – 48V. The first power converter 420A may be a boost-buck converter. Power is transferred through the first power port 112A from the first power tool 100A to the second power tool 100B via a cable 450.

The second power tool 1100B includes a second microcontroller 410B, a second power converter 420B, a second port controller 430B, and a second power port 112B. The second microcontroller 410A is communicatively connected to the second battery pack 200B (e.g., a controller of the second battery pack 200B), the second power converter 420B, and the second port controller 430B via one or more buses. The second power converter 420B is connected between the second battery pack 200B and the second power port 112B (e.g., via the second port controller 430B).

During charging, the second power port 112B receives the second voltage from the first power tool 100A via the cable 450. The second power port 112B provides the second voltage to the second power converter 420B. The second power converter 420B may increase or decrease the second voltage to a third voltage based on input from the second port controller 430B and provides the third voltage to the second battery pack 200B, e.g., via the charging terminal and negative power terminal of the second power tool 100B and the second battery pack 200B respectively. In some examples, the positive and negative power terminals may be used for both charge and discharge.

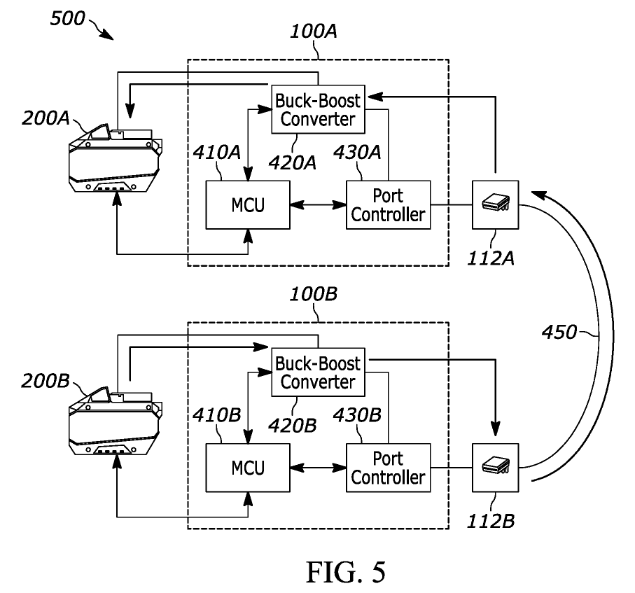

FIG. 5 is a block diagram 500 illustrating a discharge of the second power tool 100B to the first power tool 100A. During discharge, the second battery pack 200B may provide a fourth voltage to the second power converter 420B. The second power converter 420B may increase or decrease the fourth voltage to a fifth voltage based on input from the second port controller 430B and provide the fifth voltage to the second power port 112B. The second power port 112B facilitates the transfer of power from the second power tool 100B to the first power tool 100A via the cable 450.

During charging, the first power port 112A receives the fifth voltage from the second power tool 100B via the cable 450. The first power port 112A provides the fifth voltage to the first power converter 420A. The first power converter 420A may increase or decrease the fifth voltage to a sixth voltage based on input from the first port controller 430A and provide the sixth voltage to the first battery pack 200A.

FIG. 6 illustrates a first charging system 600 for a power tool 100 (e.g., a first power tool 100A), according to some embodiments. The first charging system 600 includes the power tool 100 and power devices. For example, the power devices include a battery pack charger 610, a wall adapter 615, a second power tool 100B, a top-off device 625, and a printer 630. The battery pack charger 610 charges a battery pack 200 of the power tool 100 directly. In contrast, the wall adapter 615, the second power tool 100B, the top-off device 625, and the printer 630 connects directly to the power tool 100 to provide a charging voltage to the battery pack 200 of the power tool 100. For example, the wall adapter 615, the second power tool 100B, the top-off device 625, and the printer 630 connect to the power tool 100 using a cable (e.g., USB-C cable).

The wall adapter 615 may plug into an AC wall outlet and include an inverter to convert AC voltage to a DC voltage that may be consumed by the power tool 100. The second power tool 100B may provide a DC voltage to the power tool 100 as described about with respect to FIG. 5. The printer 630 may include a USB-C port that connects to the cable to provide a DC voltage to the power tool 100.

The top-off device 625 may receive a battery pack voltage from a battery pack (e.g., an 18V battery pack) and provide a DC voltage to the power tool 100 and an AC voltage to a computer 635 (e.g., a laptop or desktop computer). For example, the top-off device 625 may include a DC-DC converter that receives battery pack voltage from the battery pack, converts the battery pack voltage to a DC voltage, and provides the DC voltage to a DC outlet on the top-off device 625. The cable may connect to the DC outlet on one end and to the power tool 100 on the other to facilitate a transfer of the DC voltage to the power tool 100. The DC-DC converter includes a step-up converter (e.g., boost converter) to convert battery pack voltage to high-voltage DC power (e.g., 18V – 120V) and a step-down converter (e.g., buck converter) to convert battery pack voltage to low-voltage DC power (e.g., 18V – 5V). The top-off device 625 may further include an inverter that receives the high-voltage DC power from the DC-DC converter and converts the high-voltage DC power to an AC output (e.g., 120 VAC power output). The AC output is then provided to an AC outlet. For example, the computer 635 may be electrically connected to the top-off device 625 at the AC outlet.

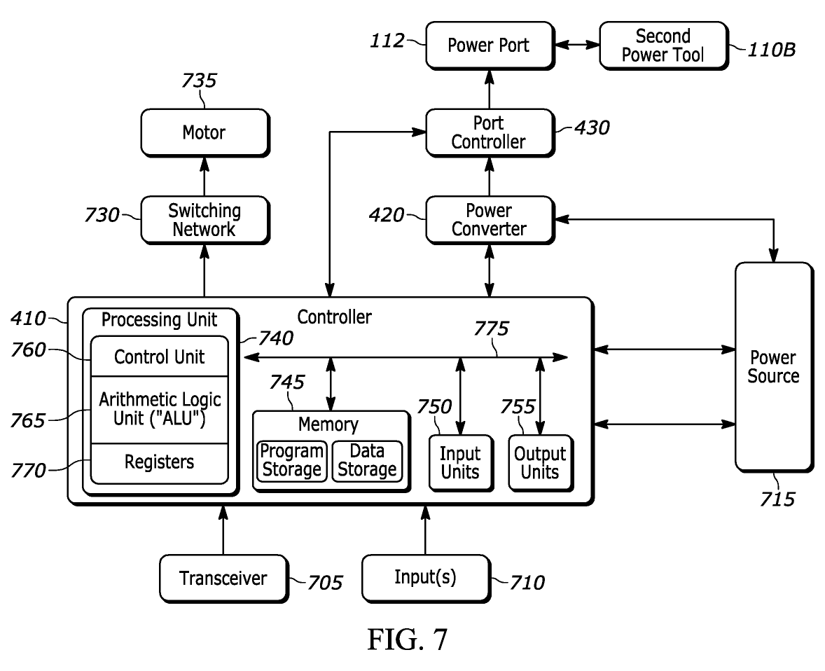

A controller 410 (e.g., controller 410A, 410B) for the power tool 100 is illustrated in FIG. 7. The controller 410 may electrically and/or communicatively connected to a variety of modules or components of the power tool 100. For example, the illustrated controller 410 is connected to a transceiver 705, input(s) 710 (e.g., user interface, trigger switch, sensors, etc.), the power source 715, a power converter 420, a port controller 430, a power port 112, and a switching network 730.

The controller 410 includes a plurality of electrical and electronic components that provide power, operational control, and protection to the components and modules within the controller 410 and the power tool 100. For example, the controller 410 includes, among other things, a processing unit 740 (e.g., a microprocessor, an electronic processor, an electronic controller, a microcontroller, or another suitable programmable device), a memory 745, input units 750, and output units 755. The processing unit 740 includes, among other things, a control unit 760, an arithmetic logic unit (“ALU”) 765, and a plurality of registers 770 (shown as a group of registers in FIG. 7), and is implemented using a known computer architecture (e.g., a modified Harvard architecture, a von Neumann architecture, etc.). The processing unit 740, the memory 745, the input units 750, and the output units 755, as well as the various modules connected to the controller 410 are connected by one or more control and/or data buses (e.g., common bus 775). The control and/or data buses are shown generally in FIG. 7 for illustrative purposes. The use of one or more control and/or data buses for the interconnection between and communication among the various modules and components would be known to a person skilled in the art in view of the embodiments described herein.

The memory 745 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 740 is connected to the memory 745 and executes software instruction that are capable of being stored in a RAM of the memory 745 (e.g., during execution), a ROM of the memory 745 (e.g., on a generally permanent basis), or another non-transitory computer readable medium such as another memory or a disc. Software included in the implementation of the power tool 100 can be stored in the memory 745 of the controller 410. The software includes, for example, firmware, one or more applications, program data, filters, rules, one or more program modules, and other executable instructions. The controller 410 is configured to retrieve from the memory 745 and execute, among other things, instructions related to the control processes and methods described herein. In other embodiments, the controller 410 includes additional, fewer, or different components.

The transceiver 705 allows for wired or wireless communication between the controller 410 and other devices, for example, the power tool battery pack 200, other power tools, an external device (e.g., mobile phone), and the like. In some embodiments, the transceiver 705 may include both a transmitter and a receiver. In other embodiments, the transceiver 705 may include a single device for transmitting and receiving. In some embodiments, the transceiver 705 receives a power transfer signal provided by a user via an external device that the controller 410 uses to start a transfer of power from the power source 715 to a second power tool 100B.

In some embodiments, the input(s) 710 include a user interface (e.g., display, actuators, etc.) and sensors (e.g., motor current sensors, motor voltage sensors, motor position sensors, power source current sensors, temperature sensors, torque sensors, trigger pull sensors, etc.). For example, a trigger pull sensor senses the amount that the trigger 110 is pulled and the force with which the trigger is pulled. In some embodiments, the controller 410 determines a shutdown condition of the power tool 100 based on the trigger pull sensor. For example, the controller 410 may determine that the power tool 100 is no longer being operated based on a lack of input from the trigger pull sensor and/or a release of the trigger pull sensor for a predetermined amount of time.

The power converter 420 (e.g., power converter 420A, 420B) may receive voltage from the power source 715 and provide a converted voltage to a power port 112 that uses the converted voltage to charge the second power tool 100B. Additionally, the power converter 420 may receive a voltage from the power port 112 (the voltage originally being from the second power tool 100B) and provide a converted voltage to charge the power source 715. The power source 715 may be a battery pack (e.g., battery pack 200). The power converter 420 is, for example, a boost-buck converter, a transformer, or the like.

The port controller 430 (e.g., port controller 430A, 430B) is configured to source or sink the power port 112 based on input from the controller 410 or communication received via the power port 112. The port controller 430 may include a separate controller similar to the controller 410 and may be provided outside the power path between the power port 112 and the power converter 420. That is, the port controller 430 may control the power flow between the power converter 420 and the power port 112 without being in the power path between the power converter 420 and the power port 112.

The motor 735 may be energized based on a state of the trigger 110. Generally, when the trigger 110 is activated, the motor 735 is energized, and when the trigger 110 is deactivated, the motor 735 is de-energized. In the illustrated embodiment, the trigger 110 is biased (e.g., with a biasing member such as a spring) such that the trigger 110 moves in a second direction away from the handle of the power tool 100 when the trigger 110 is released by the user.

The switching network 730 enables the controller 410 to control the operation of the motor 735. The switching network 730 includes a plurality of electronic switches (e.g., FETs, bipolar transistors, and the like) connected together to form a network that controls the activation of the motor 735 using a pulse-width modulated (PWM) signal. For instance, the switching network 730 may include a six-FET bridge that receives PWM signals from the controller 410 to drive the motor 735.

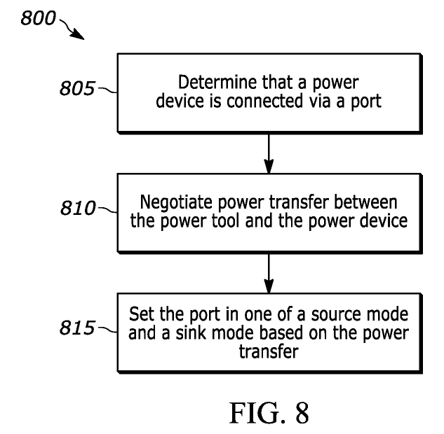

FIG. 8 illustrates a method 800 for tool to tool charging, e.g., between the first power tool 100A and the second power tool 100B, according to some embodiments. Although the illustrated method 800 includes specific steps, not all of the steps need to be performed or need to be performed in the order presented. In some embodiments, the method 800 is executed by the controller 410. The values of various thresholds or ranges described with respect to method 800 are provided as non-limiting examples and other values for such parameters are possible and may vary based on the type or condition of the power tool 100, other factors, or a combination thereof.

The method 800 includes determining, using the controller 410, that a power device is connected via the power port 112 (at step 805). The power device is, for example, a battery pack charger 610, a wall adapter 615, a second power tool 100B, a top-off device 625, and a printer 630 (see FIG. 6). In some examples, the power port 112 is a USB-C port provided on a handle of the power tool 100 (see FIG. 1). The controller 410 receives an input signal from the port controller 430 when the port controller 430 senses that a power device is connected to the power tool 100 at the power port 112. The port controller 430 may sense a current draw coming from the power port 112 when a first end of the cable 450 is inserted into the power port 112 and the power device is coupled to a second end of the cable 450.

The method 800 includes negotiating, using the controller 410, power transfer between the power tool 100 and the power device (at step 810). The controller 410 may negotiate power transfer between the power tool 100 and the power device based on a power available of the power tool 100 and a power available of the power device. For example, the controller 410 may use USB-c power delivery (PD) negotiations. The power tool 100 may both be configured as a source and sink power tool (e.g., the power tool can both provide power and receive power) or, alternatively, the power tool 100 may be designated as a sink power tool or as a source power tool based on user input (e.g., selection of a switch provided on the power tool 100). For example, based on user input (e.g., selecting a sink mode) and regardless of the state of charge of the battery pack 200 (e.g., when the state of charge of the battery pack 200 is greater than a state of charge of the power device), the power tool 100 may be designated as a sink power tool that receives power.

The method 800 includes setting, using the controller 410, the port in one of a source mode and a sink mode based on the power transfer (at step 815). In the source mode, the controller 410 (e.g., the port controller 430) sources power from a battery pack (e.g., battery pack 200) to provide to the power device. In the sink mode, the controller 410 sinks power from the power device to provide power (e.g., charge) to the battery pack 200.

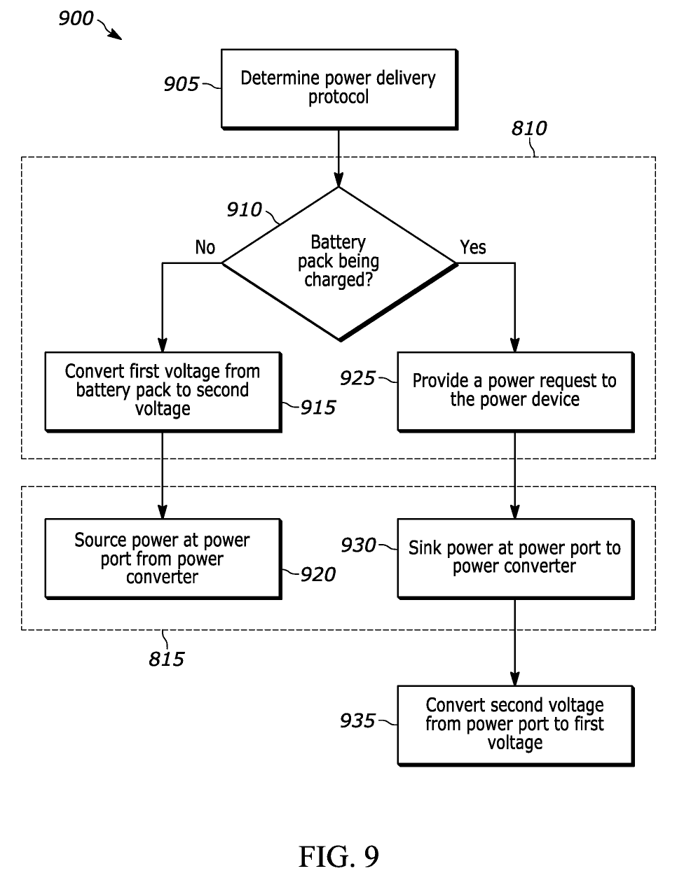

FIG. 9 illustrates a method 900 for tool to tool charging, e.g., between the first power tool 100A and the second power tool 100B, according to some embodiments. Although the illustrated method 900 includes specific steps, not all of the steps need to be performed or need to be performed in the order presented. In some embodiments, the method 800 is executed by the controller 410. The values of various thresholds or ranges described with respect to method 900 are provided as non-limiting examples and other values for such parameters are possible and may vary based on the type or condition of the power tool 100, other factors, or a combination thereof.

The method 900 includes determining, using the controller 410, the power delivery protocol (at step 905). As noted above, the power transfer using the power port 112 may be performed at different power outputs. For example, 5V – 20 V and up to 100 Watts (W) of power may be transferred using USB-C SPR standard protocol and 15V – 20V and up to 240 W of power may be transferred using USB-C EPR standard protocol. The controller 410 may determine whether the connected power device is capable of power transfer using one or both of the SPR and EPR standard protocols. The appropriate standard may be selected based on the negotiated power transfer required at steps 810 and/or as further described below.

The method 900 includes determining, using the controller 410, whether the battery pack 200 is being charged (at decision block 910). Several factors may determine whether the battery pack 200 connected to the power tool 100 is being charged. For example, the controller 410 may determine that the battery pack 200 is being charged based on a user input, e.g., a separate charge button, a specific activation of the trigger, or the like. In other examples, the controller 410 may determine that the battery pack 200 is being charged when a parameter (e.g., available power, voltage, state of charge, or the like) of the connected power device is greater than the parameter of the power tool 100. In an even further example, the controller 410 may determine that the power tool 100 is in one of a source mode or a sink mode based on user input.

When the battery pack 200 is not being charged (NO at decision block 910), the method 900 proceeds to block 915 where a discharge operation occurs. For example, the controller 410 may set the first power tool 100A to a discharge operation mode. When the battery pack 200 is being charged (YES at decision block 910), the method 900 proceeds to block 925.

The method 900 includes converting, using the power converter 420, a first voltage from the battery pack 200 to a second voltage (at block 915). A switch may be provided between the power source 715 of the power tool 100 and the power converter 420. The controller 410 control the switch to connect the battery pack 200 to the power converter 420. The first voltage is a voltage that the battery pack 200 typically provides when it is discharged. For example, the first voltage may be 12V, 18V, or 72V depending on the voltage rating of the battery pack 200. The controller 410 controls the power converter 420 to provide a second voltage to the power port 112. For example, the first power converter 420 may increase or decrease the first voltage provided from the battery pack 200 to the second voltage. The second voltage may be in a range of 5V – 48V. As noted above, the second voltage may be based on one or both of (a) a power rating of the second power tool 100B and/or the second battery pack 200B and (b) a power transfer standard (e.g., USB-C PD SPR standard or USB-C PD EPR standard). The power converter 420 may include one or more switches (e.g., GaN FETs) that are controlled by the controller 410 to convert the input power at a first voltage to output power at a second voltage.

The method 900 includes sourcing, using the port controller 430, power at power port 112 from the power converter 420 (at block 920). The port controller 430 sets the power port 112 in a source mode and provides the second voltage to the power port 112. The power from the power port 112 is transferred using the selected protocol from the power tool 100 to the power device via a cable 450. For example, the second battery pack 200B of the second power tool 100B may be charged by the first power tool 100A using the second voltage. The port controller 430 may facilitate the transfer of power using a USB-C PD SPR standard (e.g., 100W) or a USB-C PD EPR standard (e.g., 240W). For example, the port controller 430 may negotiate with the second power tool 100B to determine which standard to use to transfer power.

The method 900 includes providing, using the controller 410, a power request to the power device (at block 925). For example, the power request may include a charge power request for the battery pack 415. The power request may be transmitted from the power tool 100 to the power device via the cable 450 or via an off-band communication. The power request may also include the protocol capability (e.g., SPR or EPT).

The method 900 includes sinking, using the port controller 430, power at power port 112 to the power converter 420 (at block 930). The port controller 430 sets the power port 112 in a sink mode and provides a second voltage received at the power port 112 to the power converter 420. The power from the power port 112 is received using the selected protocol from the power device via a cable 450. The port controller 430 may facilitate the transfer of power using a USB-C PD SPR standard (e.g., 100W) or a USB-C PD EPR standard (e.g., 240W). The second voltage, as discussed above, may correspond to the transfer protocol of the power port 112 connection. The method 900 includes converting, using the power converter 420, a second voltage from the power port 112 to a first voltage (at block 935). The first voltage is, for example, a charging voltage of the battery pack 200. The charging voltage may be changed based on the charging scheme (e.g., constant current-constant voltage) used for charging the battery pack 200. The controller 410 controls the power converter 420 to provide the first voltage to the battery pack 200 using, for example, the charging terminal and the negative power terminal.

The embodiments described herein provide several advantages over prior devices. One example advantage is that the battery packs can now be charged by simply connecting the power tool to a standardized charging cable (e.g., USB-C cable). Additionally using the EPR standard protocol, the power tool battery packs may be charged at similar rating as a standard power tool battery pack charger.

Thus, various embodiments described herein provide for power tool-to-power tool charging.

What is claimed is:

1. A power tool comprising:
an interface for receiving a power tool battery pack;
a port;
a port controller connected to the port and configured to set the port in one of a source mode and a sink mode; and
a controller coupled to the interface and the port controller, the controller configured to:
determine that a power device is connected via the port,
negotiate power transfer between the power tool and the power device, and
set, using the port controller, the port in one of the source mode and the sink mode based on the power transfer.

2. The power tool of claim 1, wherein the power tool further includes:
a housing;
a power converter provided within the housing;
a port controller provided within the housing; and
a power port provided on the housing.

3. The power tool of claim 2, wherein the power port is a USB-C port.

4. The power tool of claim 2, wherein the power converter and the port controller are electrically connected to the controller, and wherein the controller is further configured to:
determine that the power tool battery pack is being charged,
provide a power request to the power device,
sink power at the power port to the power converter, and
convert, using the power converter, a first voltage from the power port to a second voltage.

5. The power tool of claim 2, wherein the power converter and the port controller are electrically connected to the controller, and wherein the controller is further configured to:
determine that the power tool battery pack is not being charged,
convert, using the power converter, a third voltage from the power tool battery pack to a fourth voltage, and
source power at the power port from the power converter.

6. The power tool of claim 2, wherein the power converter is a boost-buck converter.

7. The power tool of claim 1, wherein the power device is a second power tool.

8. The power tool of claim 1, wherein the controller is further configured to determine a power delivery protocol.

9. The power tool of claim 1, wherein power is transferred using one of a USB-C PD SPR standard and a USB-C PD EPR standard.

10. The power tool of claim 1, wherein the power tool is connected to the power device with a cable.

11. A system comprising:
a first power tool including a first power port;
a cable including a first end and a second end and connecting to the first power port at the first end; and
a second power tool including:
a second power port connected to the cable at the second end,
an interface for receiving a power tool battery pack,
a port controller connected to the second power port and configured to set the second power port in one of a source mode and a sink mode, and
a controller coupled to the interface and the port controller, the controller configured to:
determine the first power tool is connected via the second power port,
negotiate power transfer between the second power tool and the first power tool, and
set, using the port controller, the second power port in one of the source mode and the sink mode based on the power transfer.

12. The system of claim 11, wherein the second power tool further includes a power converter.

13. The system of claim 12, wherein the power converter and the port controller are electrically connected to the controller, and wherein the controller is further configured to:
determine that the power tool battery pack is being charged,
provide a power request to the first power tool,
sink power at the second power port to the power converter, and
convert, using the power converter, a first voltage from the second power port to a second voltage.

14. The system of claim 13, wherein the power converter and the port controller are electrically connected to the controller, and wherein the controller is further configured to:
determine that the power tool battery pack is not being charged,
convert, using the power converter, a third voltage from the power tool battery pack to a fourth voltage, and
source power at the second power port from the power converter.

15. The system of claim 11, wherein the cable is a USB-C cable.

16. The system of claim 11, wherein the controller determines the first power tool is connected via the second power port based on an input from the port controller.

17. The system of claim 16, wherein port controller senses a current draw at the second power port.

18. A method of charging a first power tool with a second power tool, the method comprising:
determining, with an electronic processor of the first power tool, that the second power tool is connected via a port of the first power tool,
negotiating, with the electronic processor of the first power tool, power transfer between the first power tool and the second power tool, and
setting, using a port controller of the first power tool, a port of the first power tool in one of a source mode and a sink mode based on the power transfer.

19. The method of claim 18, wherein the electronic processor determines that the second power tool is connected to the port in response to receiving an input signal from the port controller.

20. The method of claim 19, wherein the port controller provides the input signal in response to sensing a current draw coming from the port when a first end of a cable is inserted into the port and the second power tool is coupled to a second end of the cable.
